(19) United States
(12) Patent Application Publication
(10) Pub. No.: US 2023/0212365 A1
(43) Pub. Date: Jul. 6, 2023

(54) MOISTURE RESISTANT CELLULOSE FOAMS

(71) Applicants: The United States of America, as represented by The Secretary of Agriculture, Washington, DC (US); World Centric, Rohnert Park, CA (US)

(72) Inventors: GREGORY M. GLENN, GRAND JUNCTION, CO (US); RANDAL SHOGREN, COLUMBIA FALLS, MT (US); XING JIN, ALBANY, CA (US)

(21) Appl. No.: 18/090,713

(22) Filed: Dec. 29, 2022

Related U.S. Application Data
(60) Provisional application No. 63/294,900, filed on Dec. 30, 2021.

(51) Int. Cl. C08J 9/00; C08J 9/28

(52) U.S. Cl. CPC C08J 9/0095; C08J 9/009; C08J 9/28; C08J 9/0085; C08J 2401/02; C08J 2205/10; C08J 2329/04; C08J 2491/06

(57) ABSTRACT

The invention provides moisture-resistant foam compositions comprising at least one fiber component; at least one foaming agent; at least one wax binder; and optionally at least one dispersant, where the at least one fiber component, the at least one foaming agent, the at least one wax binder, and when present the at least one dispersant are uniformly dispersed throughout a matrix, wherein the matrix is a foam.

### REFERENCE TO RELATED APPLICATIONS

This application claims the benefit of U.S. Provisional Application No. 63/294,900 filed Dec. 30, 2021. The contents of this provisional patent application is hereby expressly incorporated by reference in its entirety.

### FIELD OF THE INVENTION

The disclosure provides moisture-resistant foam compositions comprising at least one renewable fiber, at least one wax binder, at least one foaming agent, and optionally at least one dispersant. The at least one fiber component, the at least one foaming agent, the at least one wax binder, and when present, the at least one dispersant are uniformly integrated throughout a foam matrix. Disclosed are also processes of making such compositions, and articles of manufacture prepared with such compositions.

### BACKGROUND OF THE INVENTION

Foam materials are important in many industrial sectors. Foaming not only confers useful mechanical and insulative properties to products but also minimizes costs by reducing the amount of material needed. Polyurethane foam (PUF), for example, has become nearly a $54 billion industry in the United States alone. Other common foam products are polyethylene (PE) and polystyrene (PS). Foams based on varieties of PUF, PE, and PS are generally used for building insulation, and many other applications, such as cushions, shoes, and helmets. Extruded PS (XPS) and expanded PS (EPS) have also become widely used in disposable single-use products such as coffee cups, trays, bowls, plates, cartons, and takeaway food containers, and in packaging materials for temperature and impact protection. Although XPS and EPS foams are lightweight, inexpensive, and have excellent properties (e.g., high thermal, moisture, and impact resistance), they are not compostable or biodegradable. This is especially problematic when the foams are used for fast food and beverage containers that are often disposed of improperly and found accumulating in waterways, beaches, along roadsides, and many other areas. Thus, there is a growing demand for food and beverage containers and protective packaging made of renewable, compostable materials. Several large cities have banned the use of polystyrene foam containers creating an additional impetus for such demand.

Containers and other packaging materials are generally designed to protect items from external damage (e.g., moisture, impacts, crushes, vibration, leakage, spills, gases, light, extreme temperatures, contamination, animal and insect intrusion, etc.) and may also contain information about the items therein. Polystyrene is a commonly and extensively used plastic for thermal and impact protection of shipped products and take-out food containers, and the like because of, for example, the ease of forming it into polystyrene foam.

Reducing the environmental footprint of disposable packaging is a societal challenge because, for polystyrene foam in particular, very little is typically re-used or recycled. Interest in sustainable solutions has led to the development of products made from renewable materials including starch, poly(lactic acid), and poly(hydroxybutyrate), among others. These ingredients continue to be pursued as sustainable materials for various containers including for food and beverage use.

Plant-based materials such as cellulose are desirable partly because they are renewable and have a lower cost. Cellulose is the most abundant polymer on earth as it is the major structural element of all plants. There are large areas devoted to growing crops such as cotton, coconut, flax, jute, sisal, kenaf, wheat, sugarcane, bamboo and other grasses as well as forests where cellulose may be harvested. In addition to lumber for building, wood is processed via heating in an aqueous slurry containing chemical additives into fibrous pulp for making paper and cardboard. The pulping process removes part of the lignin and hemicellulose which binds cellulose fibers together in wood thus, making it easier to disperse the fibers into a fine suspension. The price of pulp and paper varies considerably but is generally less than the price of commodity petroleum-based polymers making lignocellulosic materials economically attractive as replacements for petroleum-based plastics.

The use of such biodegradable and/or sustainable materials in consumer products continues to expand in various industrial sectors including packaging, construction, agriculture, and personal hygiene. Plant fibers are considered an important and inexpensive replacement for petroleum-based and other nonrenewable products for certain applications. Industrial production and existing research have been focusing on foaming in pulp slurry liquid, where a wet foam is formed and needs a later inconvenient draining as further elucidated in the next paragraph. The foam-forming technology facilitates the production of paper and paperboard with improved properties. There is also commercial interest in using fiber foam for thermal and sound insulation. Thermal insulation of cellulose loose-fill or cellulose batt is used in home insulation as an alternative to fiber glass batt insulation. However, conventional cellulose-based foams are not generally as rigid as, for example PS foams.

Most of the compostable foam technologies (e.g., cellulose fiber foam) have either cost or technology limitations, which causes continued widespread use of conventional plastic-based foams for packing and food service, among other applications. There is an established manufacturing process for making foam mats. The process first involves suspending fiber in a dilute aqueous solution containing a surfactant. The mixture is converted into a foam by incorporating air via high-speed blending, and the resultant foam is then formed into a mat sheet that is dewatered by drainage. The drainage may be facilitated by using vacuum, moderate compression, or other forces. Drainage and liquid flow are influenced by gravity and capillary forces within the fiber mat. The drainage equilibrium is reached when forces such as capillary pressure, gravity, mechanical pressure, and vacuum are balanced. At this point, the volume of liquid within the foam typically does not change and a drying phase is needed to further reduce the liquid content. Also, the foam structure may be lost if external mechanical pressure is applied. Although cellulose fiber foam is a sustainable material made of plant fiber, the conventional process begins with a foam having excessive water content, and results in a final product which is subject to substantial shrinkage during processing.

Current methods used for making cellulose foam from a wet foam are effective in making very low-density foams (less than 0.02 g/cm³). This technology is appropriate for producing thin products such as tissue papers, and the process does not fit well for making thicker products such as packaging foams with desirable qualities for commercial use. For instance, the large volume of water used for making the foam requires a lengthy dewatering step, and in addition, the foam shrinks considerably during the dewatering step making the foam dimensionally unstable. A considerable amount of the foaming agent or any other additive is also lost during the dewatering step.

There thus exists an ongoing need for moisture resistant, low-cost, compostable, dense foam products to minimize the use of plastic products, and to rely more on sustainable technologies. There exists a particular need for such products that are dense, do not require lengthy drying times, and are easily dried with minimal shrinkage to provide increased environmental and economic advantages. Previously, the inventors demonstrated a method of making foam materials, for example, from cellulose fiber using water soluble binders such as starch (U.S. Patent Application Publication No. 2020/0308359 which is incorporated by reference in its entirety). The cellulose foam was lightweight, insulative, and was rigid. However, due to the moisture vulnerability of the binder, the foam had limited resistance to water contact or to a high-humidity environment. Therefore, the foam needed to be coated or laminated with a moisture barrier film in order to provide adequate functionality in moist or humid environments. A common way to attain a moisture barrier film is to spray or paint melted wax onto the surface of the cellulose foam as a post-processing step. However, if the coating or barrier film is broken or punctured, the underlying foam is no longer protected. Besides, coating is inconvenient for foams, since the coating liquid can be easily soaked into the porous foam structure instead of staying on the surface to serve its desired function.

Thus, a process for making cellulose fiber foam that is moisture resistant, and compostable without the need of coating or laminating the foam is needed.

### SUMMARY OF THE INVENTION

Provided herein are moisture-resistant foam compositions comprising at least one renewable fiber component, at least one wax binder, at least one surfactant, and optionally at least one dispersant, processes for making such compositions, and articles of manufacture prepared with such compositions.

In an embodiment, the invention relates to a foam composition comprising at least one fiber component, at least one wax binder, at least one foaming agent, and optionally at least one dispersant; wherein the at least one fiber component, the at least one foaming agent, and the at least one wax binder are uniformly dispersed throughout a matrix. The foam compositions of the invention are water resistant. In some embodiments of the invention, the fiber component in the foam compositions of the invention is at least a plant-derived complex carbohydrate, crop waste fibers, wood, lignocellulosic fibrous material, fiber crops, or combinations thereof. In some embodiments of the invention, the at least one wax binder in the foam compositions of the invention is at least one of a natural waxy substance, a synthetic waxy substance, or a mixture thereof. In some embodiments of the invention, the at least one wax binder in the foam compositions of the invention is a paraffin wax, a carnauba wax, a candelilla wax, a beeswax, tallow, a jojoba wax, lanolin, ambergris, a soy wax, a rice bran wax, a laurel wax, stearic acid, palmitic acid, a polycarpolactone, a polylactic acid, a polyhydrobutyrate, a polybutylene succinate, or a mixture thereof. In some embodiments of the invention the at least one wax in the foam compositions of the invention is distributed essentially throughout the foam/fiber matrix. In some embodiments of the invention, the foam compositions further comprise at least one dispersant. The at least one dispersant in the foam compositions of the invention may be polyvinyl alcohol (PVOH); a pregelatinized starch; a carboxymethyl cellulose; a carboxymethyl cellulose derivative; a hydroxymethyl cellulose; a hydroxymethyl cellulose derivative; a water-soluble viscosity modifier; a plant gum; or a combination thereof.

In an embodiment, the invention relates to a process for a making a foam composition. The process comprises mixing a fiber component in water to create a hydrated fiber; removing excess water from the hydrated fiber to create a moistened fiber; blending into the moistened fiber at least one wax and optionally at least one dispersant to create a fiber with dispersed binder; mixing into the fiber with dispersed binder at least one foaming agent; and drying the foam composition. In some embodiments of the invention, the process for making a foam composition further comprises adding at least one dispersant.

In an embodiment, the invention relates to an article of manufacture made with a foam composition described herein. In some embodiments, the article of manufacture made with a foam composition described herein is compression molded. In some embodiments of the invention, the article of manufacture made with a foam composition described herein is a take-out container or a shipping container cushioning or packaging material.

### BRIEF DESCRIPTION OF THE DRAWINGS

FIG. 1A to FIG. 1I depict images of the wooden frame assembly used in the preparation of the foams of the invention. FIG. 1A depicts an image of a plastic grid on the bottom of the assembly. FIG. 1B shows an image of the lincane perforated aluminum sheet placed on top of the plastic grid. FIG. 1C depicts an image of a silk screen on top of the perforated aluminum sheet. FIG. 1D depicts an image of a wood frame placed on top of assembly. FIG. 1E shows wooden blocks used as stops inside of the wooden frame. FIG. 1F depicts an image of the fiber foam in the wooden frame. FIG. 1G shows a silk screen sheet placed on top of the foam. FIG. 1H shows a lincane perforated aluminum sheet on top of the silk screen. FIG. 1I shows a plastic grid placed on top of the lincane perforated aluminum sheet.

FIG. 2 depicts an image of a low moisture foam prepared as in Example 2.

FIG. 3A and FIG. 3B show general schemes for the process es of producing the compositions described herein. FIG. 3A presents a scheme for producing a high moisture foam. FIG. 3B depicts a scheme for producing a low moisture foam.

FIG. 4 depicts a graph of the compression stress/strain curves obtained for beaded polystyrene and polyurethane foam samples.

FIG. 5 depicts a graph of the compression stress/strain curves obtained for foam samples prepared with “low,” “medium,” “and “high” amounts of paraffin wax as a binder.

FIG. 6 depicts a graph of the compression stress/strain curves obtained for foam samples prepared with “low,” “medium,” and “high” amounts of starch as a binder.

FIG. 7 depicts a graph of the compression stress/strain curves obtained for beaded-PS and for foam samples prepared with “high” amounts of beeswax, starch, and paraffin wax.

FIG. 8 depicts a graph of the compression stress/strain curves obtained for PU foam and for foam samples prepared with “low,” “medium,” “and “high” amounts of paraffin wax as a binder.

### DETAILED DESCRIPTION

The present invention relates to moisture-resistant foam compositions comprising at least one renewable fiber, at least one wax binder, at least one foaming agent; and optionally at least one dispersant; processes for making such foam compositions, and articles of manufacture prepared with such foam compositions.

The inventors have surprisingly found that a cellulose-based foam material prepared using wax binders integrated as part of the foam and not as a coating, is moisture resistant. When adding a wax binder to an aqueous mixture of cellulose fiber and at least one foaming agent, the inventors surprisingly found that the components remained uniformly dispersed integrated throughout a matrix; the foam remained stable, and it was possible to dry it in an oven without collapsing. Surprisingly and unexpectedly, the melted wax did not drain out of the foam or aggregate to the surface of the foam during the oven drying process. The wax remained dispersed throughout the foam matrix during the oven drying process while the water in the wet foam evaporated. Also surprising was the observation that the cellulose foam did not collapse, even when a starch binder was absent. Once the foam drying process in the oven was complete, the foam was cooled to room temperature. The solidified wax acted both as a binder and a moisture repellent. As such, the cellulosic foam of the invention required no coating or lamination post-processing steps. The final product was a moisture resistant, low density foam with good insulative properties. The cellulose foam compositions of the invention have a structure similar to commercially available foams.

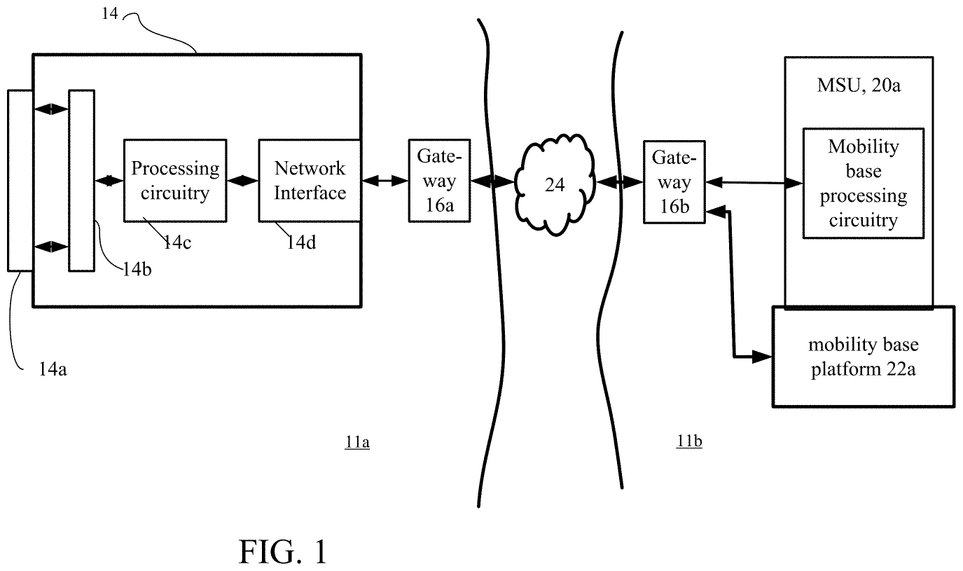

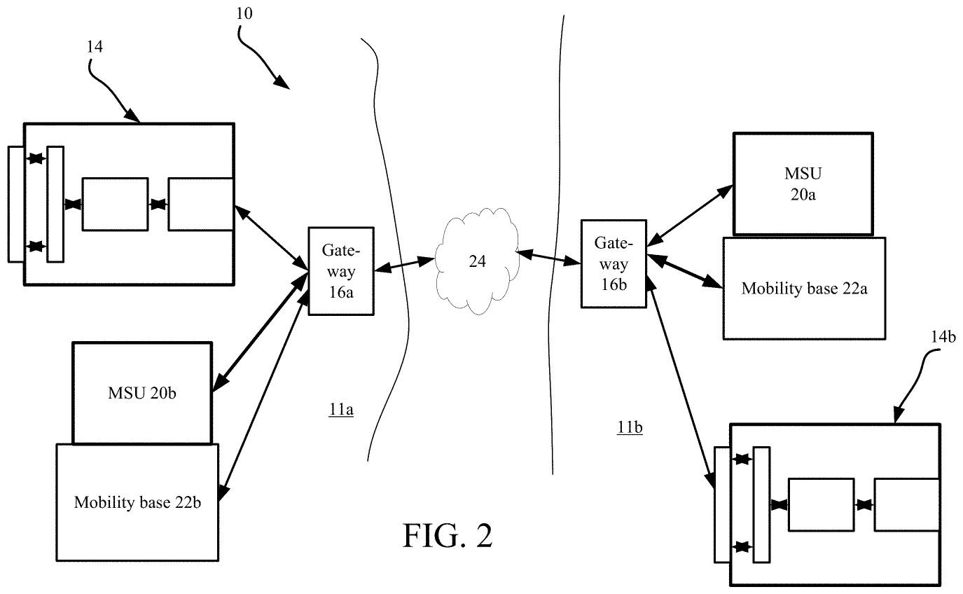

Preparation of the foams described herein may be performed by any known means. FIG. 1A to FIG. 1I show the assembly of an exemplary wooden frame used in the preparation of the foams taught herein. FIG. 1A depicts an image of a plastic grid on the bottom of the assembly. FIG. 1B shows an image of the lincane perforated aluminum sheet placed on top of the plastic grid. FIG. 1C depicts an image of a silk screen on top of the perforated aluminum sheet. FIG. 1D depicts an image of a wood frame placed on top of assembly. FIG. 1E shows two wooden blocks used as stops, inside of the wooden frame. FIG. 1F depicts an image of the fiber foam in the wooden frame. FIG. 1G shows a silk screen sheet placed on top of the foam. FIG. 1H shows a lincane perforated aluminum sheet on top of the silk screen. FIG. 1I shows a plastic grid placed on top of the lincane perforated aluminum sheet. FIG. 2 depicts an image of a low moisture foam prepared as in Example 2.

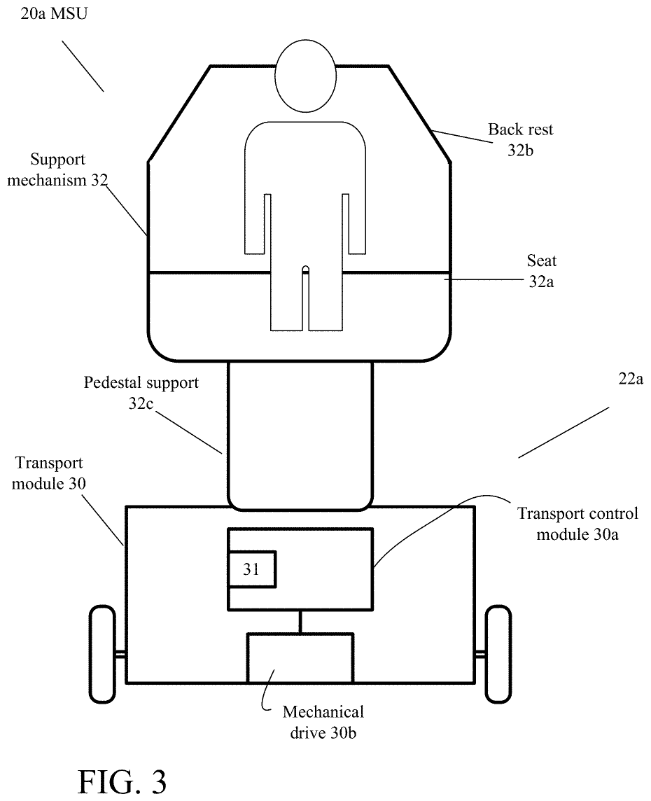

General schemes on how to make foam compositions comprising at least one fiber component, at least one foaming agent, at least one wax binder, and optionally at least one dispersant; where the components are uniformly integrated throughout a matrix are shown in FIG. 3A and FIG. 3B. The scheme shown in FIG. 3A is for a high moisture fiber preparation. Dry pulp fiber is mixed with water and allowed to hydrate. The fiber is then dewatered first by gravity and then by compression to obtain a high moisture fiber with at least 5 parts water per every part fiber. Pulverized wax in water is added to the high moisture fiber followed by a first mixing step. After addition of a foaming agent in water a second mixing step is performed, followed by molding the composition. The scheme shown in FIG. 3B is for a low moisture fiber preparation. Mixing of fiber with water, allowing the fiber to hydrate, and the first (gravity) dewatering step are the same as for the high moisture fiber preparation. Compression in a second dewatering step results in a low moisture fiber containing at least about 1 part water per every part fiber to at least about 4.5 parts water per every part fiber. A dispersant, a foaming agent, and pulverized wax are added to the low moisture fiber followed by a mixing step, followed by molding the composition. In both schemes, a drying step follows the molding of the foam to prepare articles of manufacture.

Current methods used for making cellulose foam from a wet foam are effective in making very low-density foams (about less than 0.02 g/cm³). This technology is appropriate to produce thin products such as tissue papers, but inconvenient to produce thicker products such as packaging foams. Furthermore, the large volume of water used for making the foam requires a lengthy dewatering step and, in addition, the foam shrinks considerably during the dewatering step making the foam dimensionally unstable. A considerable amount of the foaming agent or any other additive is also lost in the wastewater during the dewatering step.

There thus exists an ongoing need for low-cost, compostable, moisture resistant, rigid foam products to minimize the use of plastic products, and to rely more on sustainable technologies. To provide increased environmental and economic advantages, there exists a particular need for such products to be rigid, not require lengthy drying times, and be easily dried with minimal shrinkage.

The present invention provides novel foam compositions comprising at least one fiber component and at least one foaming agent forming a foam/fiber matrix; at least one wax binder uniformly dispersed throughout the foam/fiber matrix; and optionally at least one dispersant. Surprisingly, even though the wax binder is not a coating, the foam composition remains water resistant.

The fiber component in the novel compositions of the invention may be a plant-derived complex carbohydrate such as, wood (such as hardwood, softwood, or combinations thereof), fiber crops (such as sisal, hemp, linen, or combinations thereof), crop waste fibers (such as wheat straw, onion, artichoke, other underutilized fiber sources, or combinations thereof), or other waste products such as paper waste. However, it should be appreciated that any type of fiber known in the art may be utilized for use in the invention. The fiber component in the novel foam compositions of the invention may be at least one of a plant-derived complex carbohydrate, crop waste fibers, wood, lignocellulosic fibrous material, fiber crops, or combinations thereof.

A binder acts as an agent to hold together individual fibers in the foam. Binders normally used in the preparation of foam compositions and may be derived from natural sources such as proteins or starches from corn, wheat, soy, potato, cassava, and pea. Surprisingly the inventors have found that preparing a foam composition with a wax binder instead of a starch binder results in a foam composition that is moisture resistant. In an embodiment of the invention, the at least one wax binder in the novel foam compositions is a synthetic or natural waxy substance or a mixture thereof. In some embodiments of the invention, the at least one binder in the novel foam compositions is a paraffin wax, a carnauba wax, a candelilla wax, a beeswax, tallow, a jojoba wax, lanolin, ambergris, a soy wax, a rice bran wax, a laurel wax, a polycarpolactone, a polylactic acid, a polyhydrobutyrate, a polybutylene succinate, or a mixture thereof.

Drying of the foam compositions of the invention results in a rigid foam with a size similar to that of the moist foam. It is desirable that foam composition of the invention retains a similar volume even after drying to ensure the quality of the foam product made with such foam composition. A container or cushioning material prepared with a foam composition of the invention should be capable of holding its contents, whether stationary, in movement, or while handling, while maintaining its structural integrity and that of the materials contained therein or thereon. This does not mean that the container or cushioning material is required to withstand strong or even minimal external forces. In fact, it can be desirable in some cases for a particular container or cushioning material to be extremely fragile or perishable. The container or cushioning material should, however, be capable of performing the function for which it was intended. The necessary properties can always be designed into the material and structure of the container or cushioning material beforehand.

A container prepared with a foam composition of the invention should also be capable of containing its goods and maintaining its integrity for a sufficient period of time to satisfy its intended use. It will be appreciated that, under certain circumstances, the container can seal the contents from the external environments, and in other circumstances can merely hold or retain the contents.

Molded pulp is fiber-based material that is used for many types of shaped containers such as egg cartons, food service trays, beverage carriers, end caps, trays, plates, bowls, and clamshell containers. Molded pulp packaging is formed into shapes. It does not start as a flat sheet, instead, it is designed with round corners and complex three-dimensional shapes. To prepare molded pulp packaging, the fiber is dispersed in excess water. Molds formed of wire mesh are then lowered into the pulp mixture where vacuum draws the fiber mixture through the wire mesh. As the mixture is drawn through the mold, the fiber component is deposited on the mold surface while the water component is drawn through the mold and diverted into a holding tank. After forming, the parts are wet and need to be dried. Traditional molded pulp packaging such as egg cartons is dried on open-air drying racks. Thin-walled molded pulp packaging such as plates or bowls are dried using automatic, high temperature and high-pressure drying machines. Each product is pressed onto solid metal tools to smooth the surfaces. The foam compositions comprising fiber, at least one foaming agent, at least one wax binder, and optionally comprising at least one additional dispersant may be used in the preparation of a hybrid of molded pulp/foam packaging.

In an embodiment, the invention relates to a process for making a high moisture foam composition. The process for making a high moisture foam composition of the invention comprises mixing a fiber component in water to create a hydrated fiber; removing excess water from the hydrated fiber to create a high moisture fiber; blending into the high moisture fiber at least one wax binder to create a dispersed binder; and mixing into the dispersed binder at least one foaming agent to create a foam composition. The foam composition may be molded and dried. After removing excess water, the high moisture fiber may comprise at least about 5 parts of water per part of fiber, at least about 6 parts of water per part of fiber, at least about 7 parts of water per part of fiber, at least about 8 parts of water per part of fiber, or a portion thereof.

In an embodiment, the invention relates to a process for making a low moisture foam composition. The process for making a low moisture foam composition of the invention comprises mixing a fiber component in water to create a hydrated fiber; removing excess water from the hydrated fiber to create a low moisture fiber; blending into the low moisture fiber at least one dispersant, at least one foaming agent, and at least one wax binder to create a foam composition. The foam composition may be molded and dried. After removing excess water, the low moisture fiber may comprise at least about 1 part water per part fiber, at least about 2 parts water per part of fiber, at least about 3 parts water per part fiber, at least about 4 parts water per part fiber, at least 4.5 parts water per part fiber, or a portion thereof.

The singular terms “a”, “an”, and “the” include plural referents unless context clearly indicates otherwise. Similarly, the word “or” is intended to include “and” unless the context clearly indicates otherwise.

As used herein, the term “about” is defined as plus or minus ten percent of a recited value. For example, about 1.0 g means 0.9 g to 1.1 g.

Mention of trade names or commercial products herein is solely for the purpose of providing specific information or examples and does not imply recommendation or endorsement of such products.

It was surprising to the inventors to see that even at the lowest level of wax addition, the wax-impregnated samples floated on water whereas the control samples, without wax, almost immediately absorbed water, sank, and dispersed/disintegrated. It was also surprising that the wax impregnated foam held together when forcibly submersed in water for water submersion tests (30 seconds) whereas the control rapidly dispersed/disintegrated. It was surprising at how little wax was needed to provide moisture resistance. The amount of wax added to the foams surprisingly didn't appear to affect the foam structure and yet the foams went from immediately dispersing in water to floating and holding together when forcibly submersed in water. While paraffin wax essentially made the foam denser, the carnauba wax surprisingly had very little effect on the foam density and yet was effective in conferring moisture resistance. Surprisingly, it was not necessary to fill the pores of the foam with wax in order to confer moisture resistance or at least make the foam float on water. It appears that the wax treatment resulted in the wax melting and coating the individual fibers during the oven drying step. Also, the wax probably helped bind fibers together in areas where the individual fibers came in contact with each other. Surprisingly, only a small amount of wax was needed while still maintaining the foam structure intact. The foam structure surprisingly appeared similar to the control structure and yet it was water resistant. Water could be forced into the pores of the foam by forcing the foam under water rather than letting it float. Still, the wax was surprisingly capable of preventing the foam from dispersing/disintegrating in water as with the untreated control.

As used herein, the term “fiber” refers to a complex carbohydrate generally forming threads or filaments, which as a class of natural or synthetic materials, have an axis of symmetry determined by their length-to-diameter (L/D) ratio. Fibers may vary in their shape such as filamentous, cylindrical, oval, round, elongated, globular, or combinations thereof. The size of a fiber may range from nanometers up to millimeters. Natural fibers are generally derived from substances such as cellulose, hemicellulose, pectin, and proteins. The fiber component in the novel foams of the invention may be at least one of a plant-derived complex carbohydrate, a crop waste fiber, a wood, a lignocellulosic fibrous material, a fiber crop, or a combination thereof.

As used herein, the terms “foaming agent” and “surfactant” are used interchangeably and refer to a substance which tends to reduce the surface tension of a liquid in which it is dissolved, increasing its spreading and wetting properties. Surfactants may act as detergents, wetting agents, emulsifiers, foaming agents, or dispersants. chemical which facilities the process of forming a wet foam and enables it with the ability to support its integrity by giving strength to each single bubble of foam. The concrete industry utilizes foaming agents for making cellular concrete. Such foaming agents may also be used for making cellulose foams. These foaming agents include hydrolyzed protein formulations as well as proprietary synthetic formulations. A foaming agent for use in the preparation of the foams of the invention may be anionic, cationic, or non-ionic. Some well-known surfactants that can be used as foaming agents may include alkyl sulfates such as sodium dodecyl sulfate (SDS), alkyl ether sulfates such as sodium lauryl ether sulfate (SLES), polysorbates such as TWEEN, monoglycerides, sorbitan fatty esters, and mixtures thereof. Natural surfactants may also be used with the foam compositions described herein.

As used herein, the term “binder” refers to a compound that adheres solid constituents together to form a heterogeneous mixture of different components. Proteins and carbohydrates are commonly used as binders in the preparation of cellulose foams.

As used herein, the terms “wax” and “wax binder” are used interchangeably and refer to a solid substance consisting usually of hydrocarbons of high molecular weight, and may contain other derivative compounds such as carboxylic acid, esters, aldehydes, ketones, etc. A wax may be of mineral origin (such as ozokerite or paraffin wax) or may be one of numerous substances of plant or animal origin that differ from fats in being less greasy, harder, and more brittle, and in containing mainly compounds of high molecular weight (such as fatty acids, alcohols, and saturated hydrocarbons). Waxes may be synthetic waxes, or natural waxes. Natural waxes may be derived from plants, insects, or animals. Examples of natural waxes are carnauba wax, candelilla wax, beeswax, tallow, jojoba wax, lanolin, ambergris, soy wax, rice bran wax, and laurel wax. Synthetic, low molecular weight polyesters such as polycarpolactones, polylactic acids, polyhydrobutyrates, polybutylene succinates may also be considered waxes.

As used herein, the term “waxy starch” refers to a starch with about 100% amylopectin. This is different from the conventional definition of wax as used by default here.

As used herein, the term “dispersant” relates to any compound that when used in an aqueous environment facilitates the separation of fibers which normally tend to agglomerate into clumps or masses. In the presence of dispersant, the fibers and fillers are uniformly dispersed. The dispersant is normally a high molecular weight polymer compound. The dispersant is water soluble and has high viscosity in aqueous solution.

The clumping or agglomerating of fibers produces a heterogenous mixture and results in a weaker foam structure. Properly separating fibers using dispersants in an aqueous environment produces better intermeshing and overlapping of individual fibers and produces a strong fiber foam structure. In certain formulations a foaming agent may serve as a dispersant, in these formulations addition of an additional dispersant agent is not always necessary.

The term “effective amount” of a compound or property as provided herein is meant such amount as is capable of performing the function of the compound or property for which an effective amount is expressed. As is pointed out herein, the exact amount required will vary from process to process, depending on recognized variables such as the compounds employed, and the various internal and external conditions observed as would be interpreted by one of ordinary skill in the art. Thus, it is not possible to specify an exact “effective amount,” though preferred ranges have been provided herein. An appropriate effective amount may be determined, however, by one of ordinary skill in the art using only routine experimentation.

The term “matrix” as used herein refers to a dispersion of fiber that is intercalated with other substances such as at least one binding wax, at least one foaming agent, and/or at least one dispersant. In the matrices described herein the fiber, the at least one binding wax, the at least one foaming agent, and/or the at least one dispersant are distributed throughout a matrix without undesirable agglomeration or separation of fiber, binding wax, foaming agent, or dispersant.

The terms “ ”optional” and “optionally” are used interchangeably herein and mean that the subsequently described substance, event, or circumstance may or may not occur, and that the description includes instances in which the described substance, event, or circumstance occurs and instances where it does not. For example, the phrase “optionally at least one dispersant” means that the foam composition may or may not contain an additional dispersant, and that the Examples include compositions that contain and do not contain an added dispersant. In some instances, the foaming agent or wax binder in the foam composition act as dispersants, thus, there is no need to add at least one binder. For example, the phrase “optionally adding at least one binder” means that the method (or process) may or may not involve adding an additional binder and that this description includes methods (or processes) that involve and do not involve adding an additional binder.

Unless otherwise explained, all technical and scientific terms used herein have the same meaning as commonly understood by one of ordinary skill in the art to which this disclosure belongs.

Embodiments of the present invention are shown and described herein. It will be obvious to those skilled in the art that such embodiments are provided by way of example only. Numerous variations, changes, and substitutions will occur to those skilled in the art without departing from the invention. Various alternatives to the embodiments of the invention described herein may be employed in practicing the invention. It is intended that the included claims define the scope of the invention and that methods and structures within the scope of these claims and their equivalents are covered thereby. All publications, patents, and patent applications mentioned in this specification are herein incorporated by reference to the same extent as if each individual publication, patent, or patent application was specifically and individually indicated to be incorporated by reference.

### EXAMPLES

Having now generally described this invention, the same will be better understood by reference to certain specific examples, which are included herein only to further illustrate the invention and are not intended to limit the scope of the invention as defined by the claims.

### Example 1

Preparation of Wax/Cellulose Composite Foam

To determine the effect of wax on the properties of cellulose composite foam different waxes were used in the preparation of cellulose foams. In this Example, different wax binders were explored along with shellac, and a starch treatment that was included as a comparison.

The procedure described in this Example uses a blender in a method of making foam compositions. This method typically uses more water than the rigid foam method that uses a paddle mixer such as a HOBART or KITCHEN-AID mixer (as in Example 3, below). The foams produced can have very low density and have very good thermal insulative properties. The materials used are listed in the paragraphs below.

Fiber: Southern Bleached Softwood Kraft (SBSK) was obtained from the Columbus, Miss., USA paper mill (International Paper, Global Cellulose Fibers; 6400 Poplar Avenue, Memphis, Tenn., USA). This grade of Southern pine fiber has high brightness, exceptional balance of tear and tensile strength, and provides bulk, making it suitable for a variety of tissue, paper, and packaging applications. This fiber is FDA compliant for food contact. Sample IDs used were CO-SBSK, CXOE05020, May 5, 2020, COLUMBUS.

Foaming Agent: A 29% liquid solution of Sodium Dodecyl Sulfate also known as Sodium Lauryl Sulfate (SDS) was obtained from CHEMISTRYSTORE.COM (The Chemistry Store; 1133 Walter Price St., Cayce, S.C., USA).

Starch: Waxy corn pregel (HIFORM 12744) was obtained from CARGILL, PO Box 9300, Minneapolis, Minn., 55440-9300, USA.

Waxes were obtained from Gulf Wax, Royal Oaks Enterprises; Roswell, Ga., 30076, USA: Paraffin wax with a melting temperature range of 46° C. to 68° C. Soy wax with a melting temperature range of 49° C. to 82° C. Carnauba wax has a melting temperature range of 82° C. The melting temperature range of beeswax is 62° C. to 66° C.

Shellac: Two water soluble shellac formulations were provided by Tony Chuffo of Coriell Associates Inc., Specialty Coatings and Services; 149 Coriell Avenue, Fanwood, N.J., USA. Shellac flakes were purchased from AMAZON (Seattle, Wash., USA).

Silk Screen: A 160 mesh (about 88.5 μm opening) polyester monofilament TERYLENE screen, with a melting temperature of 250° C. to 260° C. was purchased from MS WGO; AMAZON.

Perforated aluminum sheet: A lincane perforated aluminum sheet was obtained from THE HOME DEPOT; Atlanta, Ga., USA.

Plastic Grid: A suspended egg crate light ceiling panel cut to size was obtained from THE HOME DEPOT.

Wood Frame: Made by removing bottom of wood filing box obtained from HOBBY LOBBY; Oklahoma City, Okla., USA.

The materials and amounts used to prepare the different formulations are listed below in Table 1. In brief, 25 g fiber was shredded and added to a blender (BLENDTEC, 75 oz square jar) with warm (60° C.) tap water (approximately 1:70, fiber:water or 1.5% fiber). The mixture was blended for approximately 30 seconds to disperse the fiber in water. The mixture was allowed to stand for about 10 to 15 minutes to hydrate fiber. The hydrated fiber mixture was blended again for 60 seconds and then poured through a 50 mesh screen (about 0.3 mm openings) on which the fiber was deposited. The fiber was rinsed with cool tap water then gathered into a ball and gently squeezed until the fiber:water weight reached 200 g total (25 g fiber+175 g water) to create a moistened fiber.

To prepare a wax/cellulose foam, the moistened fiber was set aside while two hundred grams of cold tap water were added to the blender along with the amount of wax shown in Table 1. The wax was weighed and added to 200 g water. The water/wax mixture was blended on high for 2 minutes to adequately pulverize the wax into a fine powder. The moistened fiber that was set aside earlier was then added to the blender contents. The contents were then blended for 15 seconds. Two grams of SDS was then added to the blender and the contents were blended for an additional 1 minute. The mixture formed a wet foam in which the fiber and wax components were thoroughly dispersed.

To prepare a waxy starch/cellulose foam, the ball of wet fiber (200 g) was added to the blender along with 200 g additional water. A waxy starch powder with about 100% amylopectin was added gradually to the mixture while intermittently blending to avoid the powder from forming lumps. Once the starch was dispersed, 4 g of SDS were added. The higher amount of SDS was needed to achieve adequate foaming due to the anti-foaming effect of starch. The contents were blended for 1 minute. The mixture formed a wet foam in which the fiber and starch were thoroughly dispersed.

TABLE 1
FORMULATIONS

| | | Fiber (g) | Water (g) | Binder | SDS (g) |
|---|---|---|---|---|---|
| Control | | 25 | 375 | 0 | 2 |
| | Low | 25 | 375 | 3.5 | 4 |
| Starch (g) | Medium | 25 | 375 | 7 | 4 |
| | High | 25 | 375 | 14 | 4 |
| | Low | 25 | 375 | 3.5 | 2 |
| Wax (g) | Medium | 25 | 375 | 7 | 2 |
| | High | 25 | 375 | 14 | 2 |
| | Low | 25 | 375 | 3.5 | 2 |
| Shellac (mL) | Medium | 25 | 375 | 7 | 2 |
| | High | 25 | 375 | 14 | 2 |
| | Low | 25 | 375 | 3.5 | 2 |
| Soy (g) | Medium | 25 | 375 | 7 | 2 |
| | High | 25 | 375 | 14 | 2 |

To prepare a shellac/cellulose foam, the ball of wet fiber (200 g) was added to the blender along with 200 g of additional water minus the volume of liquid shellac added as shown in Table 1. Two grams of SDS was added and the contents were blended for 1 minute. To prepare the shellac 3.5 g, 7.0 g, or 14 g of shellac flakes were added to a blender and water was added to bring to 200 g. The mixture was blended for 60 seconds to pulverize the flakes. The ball of moistened fiber (200 g) was added to the blender along with 2 g SDS and blended for 60 seconds.

The fiber foam was poured and/or scooped into the wooden frame assembly depicted in FIG. 1A to FIG. 1I. The Soy wax behaved as an anti-foaming agent, so it was not possible to make foam sheets from the soy wax containing foam. To start the assembly, a plastic grid was put on the bottom of the setting as depicted in FIG. 1A. The plastic grid provides support and allows excess water to drain out. A lincane perforated aluminum sheet was placed on top of the plastic grid as seen on FIG. 1B. A silk screen was put on top of the perforated aluminum sheet as seen on FIG. 1C. As shown on FIG. 1D, a wood frame was placed on top of assembly, followed by the addition of two wooden blocks inside of the wooden frame, as stops, as depicted in FIG. 1E. Finally, as shown in FIG. 1F the fiber foam was poured and/or scooped into the wooden frame.

As seen in FIG. 1G, a silk screen sheet was placed on top of the foam, followed by a lincane perforated aluminum sheet, shown in FIG. 1H. Lastly, as depicted on FIG. 1I, a plastic grid was placed on top of the perforated aluminum sheet. The plastic grid was then pressed down until it contacted the wood spacers. Once the foam was compressed to the thickness of the blocks, a few minutes were allowed for excess water to drain out the bottom of the assembly. The wooden frame was then carefully lifted off the assembly, followed by removal of the plastic grid and the perforated aluminum sheet, and finally carefully peeling off the silk screen sheet. A thin knife may then be used to separate and remove the wood blocks. This leaves the top surface and sides of the foam exposed. The compression step described above collapses the foam on the top and bottom surfaces forming a paper-like surface with the foam sandwiched in between.

The foam was then lifted by the bottom perforated aluminum sheet and placed in an oven set at 105° C. Foam samples were removed periodically from the oven to measure weight loss. The foam was dried until there was no further weight loss observed.

The finished, dry foam was low density, with a paper-like coating on the surface. When wax samples were placed in a pan of water, they simply floated on the surface of the water although there was some moisture absorbed into the pores of the foam.

To measure the wet density of the different foams, once the foam was formed, a cup was filled with foam and the weight was recorded in g/cm³. The volume of a cup is 236.6 cm³. The tare weight of the cup was 30.72 g. The foam weight was determined by subtracting the tare weight from the total weight of the foam. The wet density was recorded as the foam weight divided by the volume.

The dry foam was lightweight. The foam did not have enough internal strength to not slightly collapse or shrink. The initial thickness (Ti) of the wet foam and the final thickness (Tf) of the dry foam were measured with a micrometer. The amount of shrinkage was determined by the following formula (1):

Shrinkage (%)=(1−(Tf/Ti))×100 (1)

For the immersion test, cut foam samples (about 18 cm²) were submerged in tap water (20° C.) for 30 seconds. The weight of the foam sample was recorded before (Wi) and after (Wf) the immersion test. The weight gain (%) was recorded using the following formula:

Weight gain increase (%)=(Wf/Wi)×100 (2)

Foam samples approximately 25 mm² were dried in the oven at 105° C. for 2 hours. The samples were then placed in an incubator at 95 to 100% relative humidity (RH) for 48 hours. The percent weight gain was calculated using equation (2).

Foam samples were conditioned to 50% relative humidity for 48 hours prior to testing. This was accomplished by placing the samples in a sealed chamber containing a saturated salt (Mg(NO₃)₂) and a small circulating fan. Compressive strength at 10% deformation was determined in foam samples that were compressed at a rate of 2.5 mm per minute using a universal testing machine (Mark-10 model ESM 303). Compressive modulus, a measure of stiffness, was determined from the linear slope of the stress/strain curve.

### Results

The blender process was very fast and efficient in making fiber foam samples. The foams produced had a small cell size and fiber dispersion was excellent. As seen in Table 2, below, the wet foam density (in g/cm³) was positively correlated with the concentration of binder used in the formulation. The wet foam density was a useful measurement because it was correlated with the final dry density shown in Table 3, below. Soy wax was also tested but not included in the results due to its anti-foaming properties. Very little foaming occurred during mixing of formulations containing soy wax, even when high amounts of SDS (4 g) were used. Starch moderately suppressed foaming with SDS but foaming was adequate when using higher SDS levels (4 g).

TABLE 2
WET FOAM DENSITY (g/cm³)

| | | | | | | | Shellac |
|---|---|---|---|---|---|---|---|
| Binder | | | Car- | Bees- | Shellac | Shellac | Dry |
| Amt. | Starch | Paraffin | nauba | wax | NF | G | Powder |
| Control (0 g) | 0.244 | 0.244 | 0.244 | 0.244 | 0.244 | 0.244 | 0.244 |
| Low (3.5 g) | 0.27 | | | 0.37 | 0.20 | 0.246 | 0.290 |
| Medium (7.0 g) | 0.40 | | | 0.45 | 0.198 | 0.289 | 0.269 |
| High (14 g) | 0.57 | | 0.29 | 0.51 | 0.203 | 0.263 | 0.286 |

The range of density of the dry foams is seen in Table 3. While thermal conductivity tests have not yet been performed, it is anticipated that all of the foam samples will have excellent thermal properties. Thermal conductivity is typically correlated with dry density; the low-density samples having lower thermal conductivity. The control sample containing no binder had the lowest dry density.

TABLE 3
DRY FOAM DENSITY (g/cm³)

| | | | | | | | Shellac |
|---|---|---|---|---|---|---|---|
| Binder | | | Car- | Bees- | Shellac | Shellac | Dry |
| Amt. | Starch | Paraffin | nauba | wax | NF | G | Powder |
| Control (0 g) | 0.026 | 0.026 | 0.026 | 0.026 | 0.026 | 0.026 | 0.026 |
| Low (3.5 g) | 0.025 | 0.032 | 0.026 | 0.072 | 0.023 | 0.026 | 0.040 |
| Medium (7.0 g) | 0.045 | 0.051 | 0.047 | 0.072 | 0.031 | 0.031 | 0.040 |
| High (14 g) | 0.107 | 0.067 | 0.051 | 0.13 | 0.025 | 0.034 | 0.048 |

Due to the excellent fiber dispersion in the high shear mixing from the blender, the fibers were held together most likely by physical intertwining, but also perhaps by some hydrogen bonding. The compression step formed a paper-like coating on the foam which also help hold the samples together. These results show that extremely low-density foams can be made by the high-shear blending method and that some fiber cohesion occurs even without a binder.

The waxy starch binder suppressed the foaming so 4 g SDS were used with starch as the binder. As seen in Table 3, above, the foam density at 3.5 g was comparable to the density of the control. However, the control required only 2 g SDS. Foam density increased with increasing amounts of starch. The density of dry foams containing starch was typically as high or higher than samples containing wax except for beeswax.

Paraffin wax was milled into a powder in water using a blender and mixed with the fiber as described in the procedure section above. After adding 2 g SDS the mixture readily foamed. The paraffin mixture foamed readily and once formed into a sheet and dried, it formed nice, low density sheets, as seen in Table 3, above. One observation was that during the oven drying step, the foam sheets collapsed slightly and densified. This is understandable since paraffin wax is a pourable liquid above 82° C. Perhaps if the foam were dried at 40° C., the foam would not collapse slightly. The trade-off is that the foam would take longer to dry. It is also noteworthy that the foam absorbed the paraffin into its matrix and the liquid paraffin did not leak from the bottom of the foam.

As seen in Table 3, above, the carnauba wax resulted in the lowest density dry foams of all the binders tested. Even with 14 g of carnauba wax, the dry foam was low density. As with the paraffin wax, the carnauba wax was completely absorbed into the foam matrix. Foams containing carnauba wax did not collapse as much as observed with the foams containing paraffin wax. This may be due to the higher melting temperature of the carnauba wax.

The beeswax had some anti-foaming behavior. As seen in Table 2, the wet density of the foam comprising beeswax was similar to the foam comprising starch and higher than the foams comprising paraffin wax or carnauba wax. As seen in Table 3, the foams comprising beeswax had the highest dry density of all the binders tested. Perhaps adding more SDS as was done with the starch sample would have decreased the wet and dry densities. As with the other wax samples, the fiber matrix effectively absorbed any melted wax during the drying process, even at the 14 g level.

The foams comprising shellac readily foamed. This may be due to the presence of a surfactant in the shellac formulations. The formulations are proprietary, but it seems reasonable that the shellac liquids were emulsions that made them water soluble. With the 14 g sample, there was a residue deposited on the inside of the blender container. It may be that some of the shellac came out of solution during the foaming step while the surfactant that remained contributed to the foaming process. The shellac NF was very low density for all of the concentration levels tested.

As seen in Table 4, below, the shrinkage (%) during oven drying typically increased as the amount of binder increased in the formulation. Except for the beeswax samples where the amount of shrinkage appeared to be inconsistent with dry density. However, as shown in Table 2, the wet density data show that these samples didn't foam well which explains how dry density can be high even when shrinkage is low. The carnauba samples had comparatively little shrinkage and relatively low wet density which is consistent with the low dry density values observed. The paraffin and starch samples had similar amounts of shrinkage. The shellac-NF samples had very little shrinkage, even at high concentrations.

TABLE 4
OVEN DRYING (105 C) SHRINKAGE

| | | | Car- | Bees- | Shellac | Shellac | Shellac |
|---|---|---|---|---|---|---|---|
| Binder | Starch | Paraffin | nauba | wax | NF | G | Flakes |
| Control (0 g) | 24% | 24% | 24% | 24% | 24% | 24% | 24% |
| Low (3.5 g) | 23% | 26% | 15% | 44% | 23% | 24% | 34% |
| Medium (7.0 g) | 33% | 35% | 25% | 34% | 15% | 27% | 31% |
| High (14 g) | 45% | 40% | 15% | 25% | 15% | 31% | 23% |

Table 5 below shows the drying time (in hours) in an oven at 105° C. The fastest drying times were obtained for the control samples that contained no binder and for some of the shellac samples. The longest drying times obtained were for the starch samples. This result is not surprising since starch has a great affinity for water. The drying times for the paraffin samples were slightly longer than those of the control. This is understandable since the higher the amount of paraffin added, the denser the sample became, which would reduce the evaporation rate. The carnauba samples had relatively less shrinkage and densification, and had drying times similar to the control. The beeswax samples had long drying times which is likely due to the densification of the fiber matrix slowing the evaporation rate. The shellac had minimal effect on the drying rate of the samples, and for some samples shellac even seemed to improve the drying rate.

TABLE 5
DRYING TIMES (hours) IN 105° C. OVEN

| | | | Car- | Bees- | Shellac- | Shellac- | Shellac |
|---|---|---|---|---|---|---|---|
| Binder | Starch | Paraffin | nauba | wax | NF | G | Flakes |
| Control (0 g) | 2.5 | 2.5 | 2.5 | 2.5 | 2.5 | 2.5 | 2.5 |
| Low (3.5 g) | 3.0 | 2.8 | 2.5 | 4.5 | 2.0 | 1.9 | 2.2 |
| Medium (7.0 g) | 4.5 | 3.0 | 2.75 | 4.25 | 1.5 | 2.25 | 2.5 |
| High (14 g) | 6.5 | 3.0 | 2.4 | 4.4 | 2.0 | 2.7 | 3.25 |

As seen in Table 6 samples that were completely immersed in water behaved in different ways. The control sample almost instantaneously was enveloped with water and quickly dispersed and lost all structure and form. The low starch sample behaved similar to the control sample but persisted in the water and could be removed after the 30 second test although it did not maintain its shape. The medium and high starch samples absorbed high amounts of water but maintained their shape and could be removed from the water intact. Adding the lowest amount of wax (3.5 g) had a dramatic effect on water absorption compared to the control sample. Increasing the wax content further generally reduced water absorption further but to a lesser degree. All the wax samples floated in the water but still absorbed water during the submersion test. Samples with beeswax absorbed the least amount of water. Surprisingly, the shellac samples absorbed high amounts of water. They seemed to hold their shape while allowing the matrix to fill with water by capillary action. It was difficult to obtain an accurate water absorption value for control samples and low starch samples because they were unstable in water and collapsed.

TABLE 6
WATER ABSORPTION (%) AFTER A 30 SECOND IMMERSION TEST

| | | | | | Shellac- | Shellac- | Shellac |
|---|---|---|---|---|---|---|---|
| Binder | Starch | Paraffin | Carnauba | Beeswax | NF | G | Flakes |
| Control (0 g) | 1,595 | 1,595 | 1,595 | 1,595 | 1,595 | 1,595 | 1,595 |
| Low (3.5 g) | 2,217 | 574 | 361 | 44 | 1,531 | 2,342 | 2,162 |
| Medium (7.0 g) | 1,632 | 252 | 329 | 34 | 2,200 | 2,379 | 2,037 |
| High (14 g) | 1,130 | 124 | 348 | 25 | 2,297 | 2,237 | 1,649 |

Following the 30 second immersion test, the samples were allowed to air-dry, and the amount of shrinkage is shown in Table 7. The amount of shrinkage that occurred was very little (less than about 3%) in the samples containing paraffin, beeswax, and carnauba wax. The results show that the samples with wax had very little dimensional change after immersion and dried with only minor shrinkage. The starch samples, however, had a high amount of shrinkage during the drying step. The shellac NF and Shellac G samples absorbed a high amount of water and had a high degree of shrinkage during air drying. The shellac flakes samples absorbed a high amount of water but maintained their shape better. The samples with high amount of shellac (14 g) collapsed less during drying.

TABLE 7
SHRINKAGE AFTER DRYING FROM A 30 SECOND IMMERSION TEST

| | | | | | Shellac | Shellac | Shellac |
|---|---|---|---|---|---|---|---|
| Binder | Starch | Paraffin | Carnauba | Beeswax | NF | G | Flakes |
| Control (0 g) | Collapse | Collapse | Collapse | Collapse | Collapse | Collapse | Collapse |
| Low (3.5 g) | 55% | 1.6% | 2.1% | 1.4% | 82% | 64% | 27% |
| Medium (7.0 g) | 37% | 1.5% | 2.2% | 1.8% | 39% | 47% | 42% |
| High (14 g) | 17% | 1.45% | 2.3% | 2.0% | 50% | 37% | 9.5% |

The control sample absorbed 26% moisture after being incubated in 100% RH. The paraffin and beeswax treatments decreased the amount of water absorbed at 100% RH. The carnauba wax samples were unusual with a higher amount of moisture absorption. The starch samples had higher moisture absorption than the control.

TABLE 8
WEIGHT GAIN OF OVEN-DRIED FOAM SAMPLES IN 100% RH

| | | | Car- | Bees- | Shellac | Shellac | Shellac |
|---|---|---|---|---|---|---|---|
| Binder | Starch | Paraffin | nauba | wax | NF | G | Flakes |
| Control (0 g) | 26.4% | 26.4% | 26.4% | 26.4% | 26.4% | 26.4% | 26.4% |
| Low (3.5 g) | 27.3% | 24.8% | 33% | 24.9% | 31.3% | 28.7% | 30.7% |
| Medium (7.0 g) | 32.1% | 20.7% | 31% | 23.7% | 30.9% | 29.5% | 24.0% |
| High (14 g) | 31.7% | 17.6% | 34% | 17.5% | 27.6% | 31.9% | 20.9% |

Data for the compressive strength and stiffness (modulus) determined for a soft foam (polyurethane cushion) and for a rigid foam (beaded polystyrene) are shown in Table 9. Where the foam density was determined by volume and weight measurements. Even though the density was similar for both foam samples, the mechanical properties were very different. The polyurethane foam was easily compressed and readily rebounded after compression which makes it useful for cushioning applications. The beaded polystyrene (beaded-PS) foam was rigid with much higher compressive strength.

TABLE 9
SOFT FOAM AND RIGID FOAM COMPRESSIVE
STRENGTH AND STIFFNESS

| | | Compressive | Compressive |
|---|---|---|---|
| Sample | Density (g/cm³) | Strength (kPa) | Modulus (kPa) |
| Polyurethane | 0.0159 | 2.44 (0.435) | 0.306 (0.0196) |
| Beaded Polystyrene | 0.0136 | 64.3 (0.065) | 18.4 (0.945) |

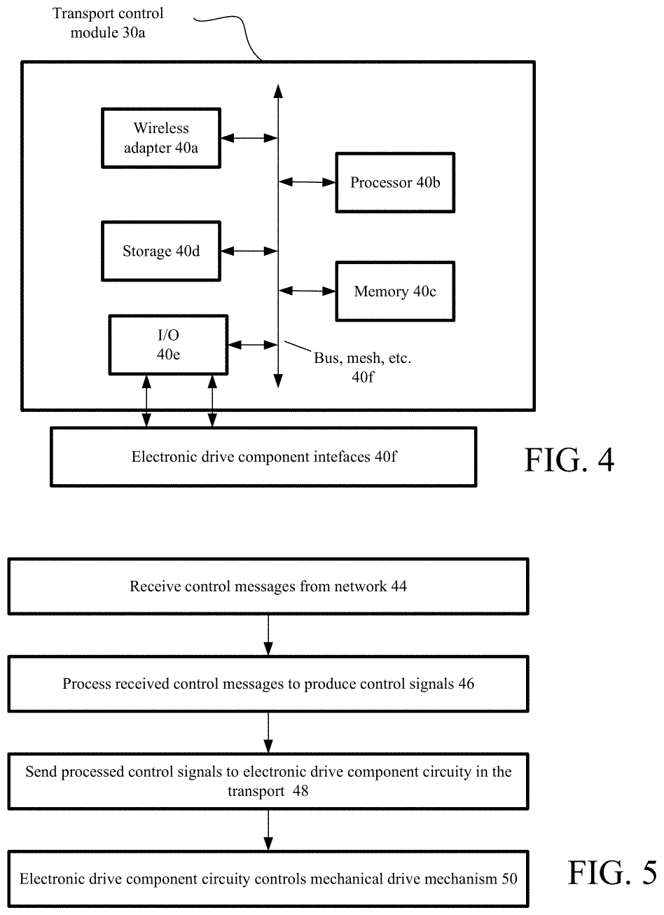

The compressive stress/strain curves for foam samples showed that the beaded-PS had a yield point at approximately 3% deformation. As seen in FIG. 4, after the yield point, the beaded PS foam sample continued to increase in compressive resistance but at a different rate.

The compressive strength (kPa) of foam samples at 10% deformation is shown in Table 10, where the standard deviation is included in parenthesis. As seen in Table 10, the compressive data for the fiber foam samples showed that the foam was similar to the soft polyurethane foam. The strength of the foam samples generally increased as the amount of binder increased from “low” to “high.” At the “high” level, the starch and beeswax samples had the greatest strength. The paraffin and carnauba wax samples had intermediate strength while the shellac NF and shellac G samples had very low compressive strength, even at the “high” level.

TABLE 10
COMPRESSIVE STRENGTH (kPa) OF FOAMS AT 10% DEFORMATION

| | | | Car- | Bees- | Shellac | Shellac | Shellac |
|---|---|---|---|---|---|---|---|
| Binder | Starch | Paraffin | nauba | wax | NF | G | Flakes |
| Control (0 g) | 0.694 | 0.694 | 0.694 | 0.694 | 0.694 | 0.694 | 0.694 |
| Low (3.5 g) | 0.96 | 1.05 | 2.18 | 3.96 | 0.486 | 1.04 | 1.97 |
| Medium (7.0 g) | 3.16 | 3.35 | 3.80 | 4.64 | 1.40 | 1.50 | 1.49 |
| High (14 g) | 21.1 | 5.98 | 4.23 | 26.9 | 0.456 | 1.14 | 3.26 |

The stiffness (modulus) reflected the results of the compressive strength. The compressive moduli (kPa) of foam samples are shown in Table 11, where the standard deviations are included in parenthesis. As seen in Table 11 the modulus generally increased with increasing amounts of binder except for the shellac NF and shellac G samples. The highest moduli were observed for the starch and beeswax samples containing “high” amount of binder.

TABLE 11
COMPRESSIVE MODULI (kPa) OF FOAM SAMPLES

| | | | Car- | Bees- | Shellac- | Shellac- | Shellac |
|---|---|---|---|---|---|---|---|
| Binder | Starch | Paraffin | nauba | wax | NF | G | Flakes |
| Control (0 g) | 0.069 | 0.069 | 0.0694 | 0.069 | 0.069 | 0.069 | 0.069 |
| Low (3.5 g) | 0.0954 | 0.11 | 0.218 | 0.394 | 0.050 | 0.1034 | 0.192 |
| Medium (7.0 g) | 0.315 | 0.335 | 0.384 | 0.444 | 0.134 | 0.152 | 0.15 |
| High (14 g) | 2.11 | 0.598 | 0.423 | 2.69 | 0.0456 | 0.123 | 0.318 |

As seen in FIG. 5, the stress/strain curves for the paraffin wax samples show that in contrast to the beaded-PS sample, the stress increases linearly within the stain range tested with no distinct yield point.

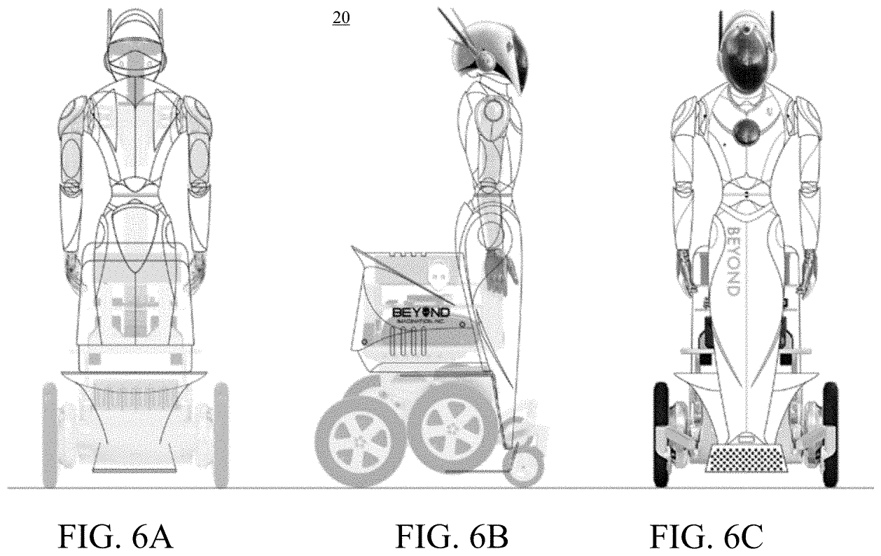

The stress/strain curves for the starch binder are shown in FIG. 6 and show a considerable increase in strength at the “high” level of binder. The increase in strength is most likely due to two factors, densification during drying and the higher amount of binder. This is in contrast to the paraffin wax sample in FIG. 5 that is more or less directly proportionate to the amount of binder.

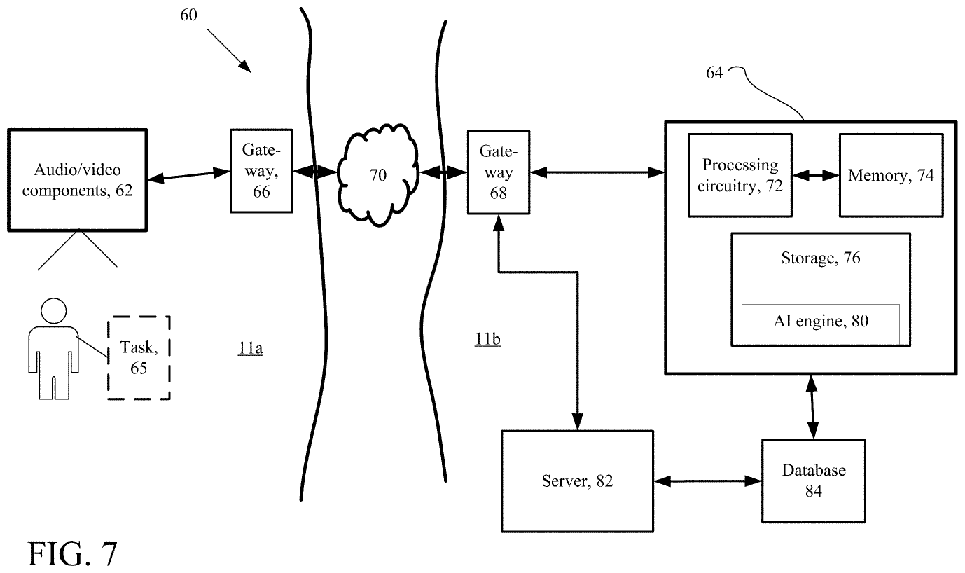

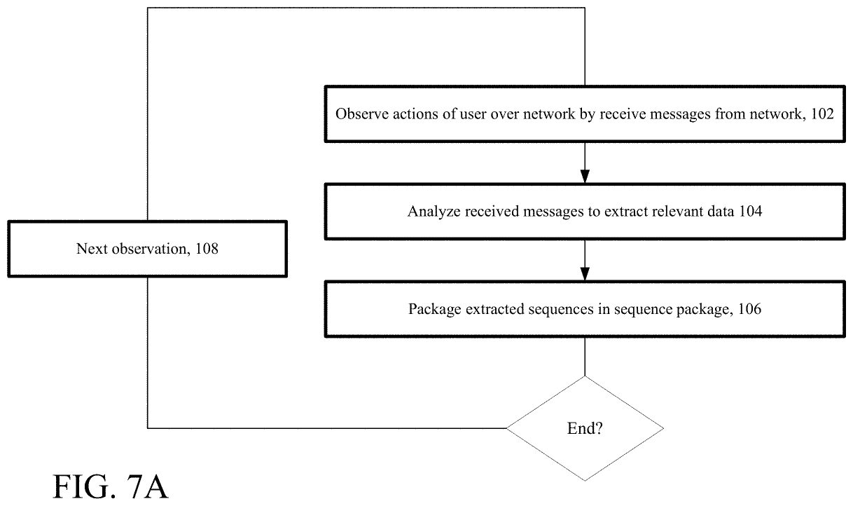

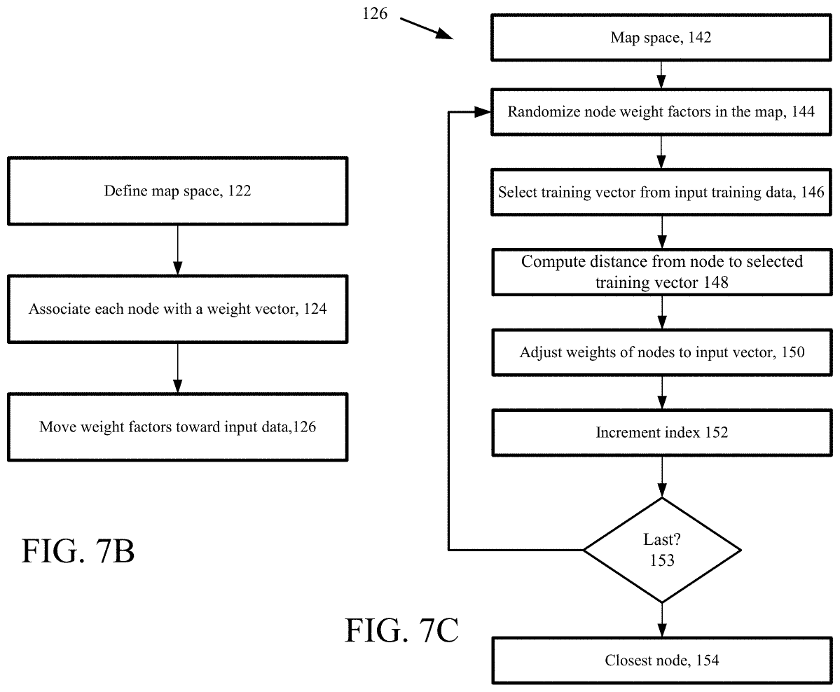

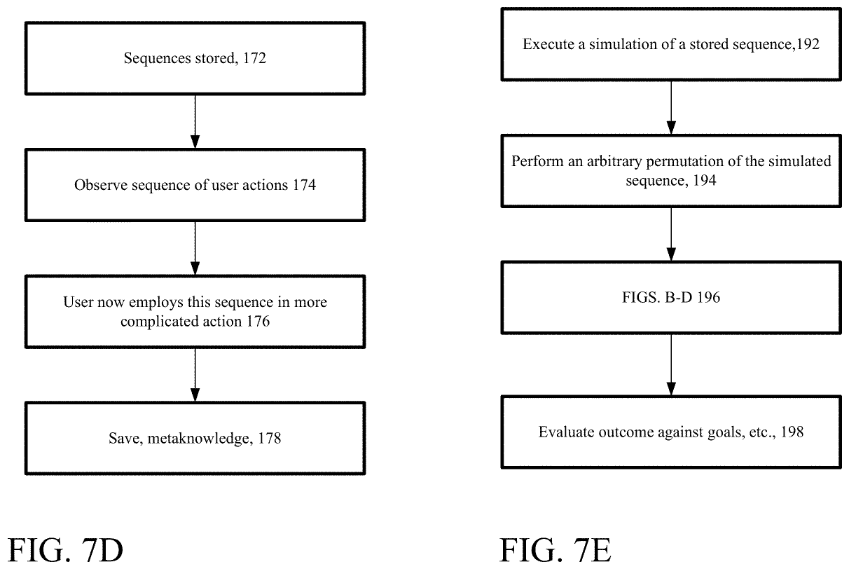

The stress/strain curves for the “high” level of beeswax, starch, and paraffin in comparison to the beaded PS is shown in FIG. 7. The “high” level of beeswax and starch resulted in foam samples that had the highest compressive strength but still not as high as the beaded-PS. The likely reason why the beeswax and starch samples were so strong may be because the density of these samples was also the highest (see Table 3). These samples have approximately 10 times the density of the beaded-PS and still have less than half the strength. The paraffin sample had much lower density (Table 3) than the starch and beeswax samples which explains its lower strength values.

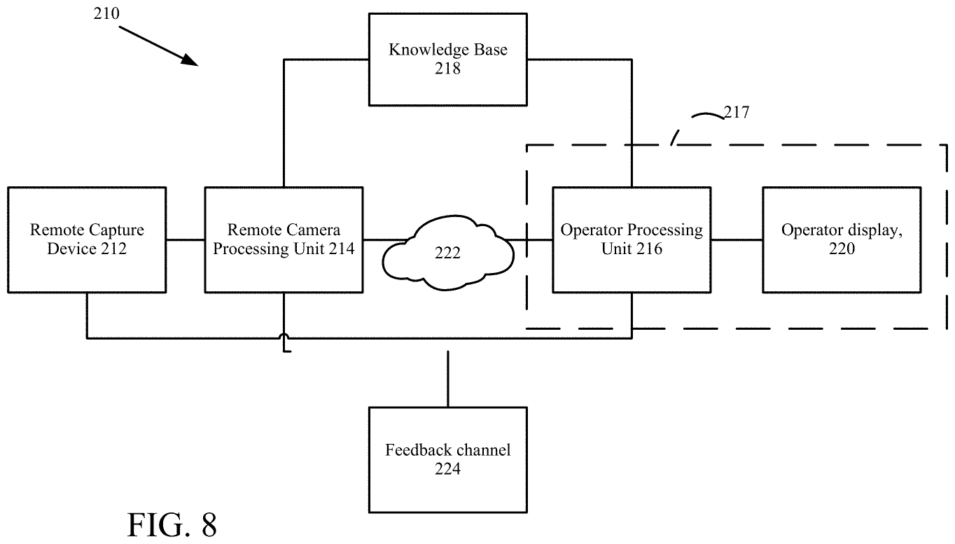

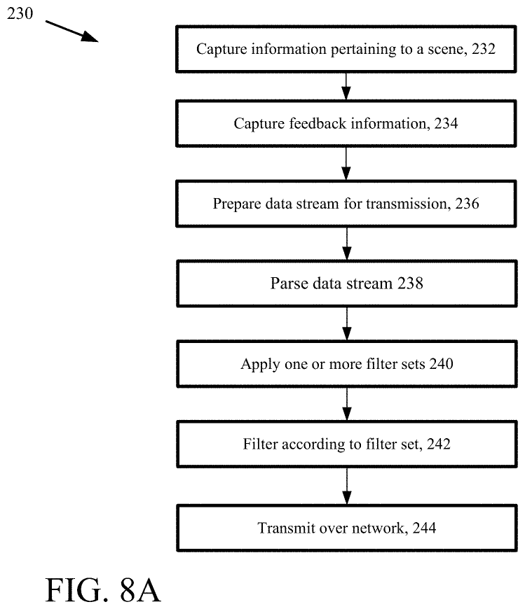

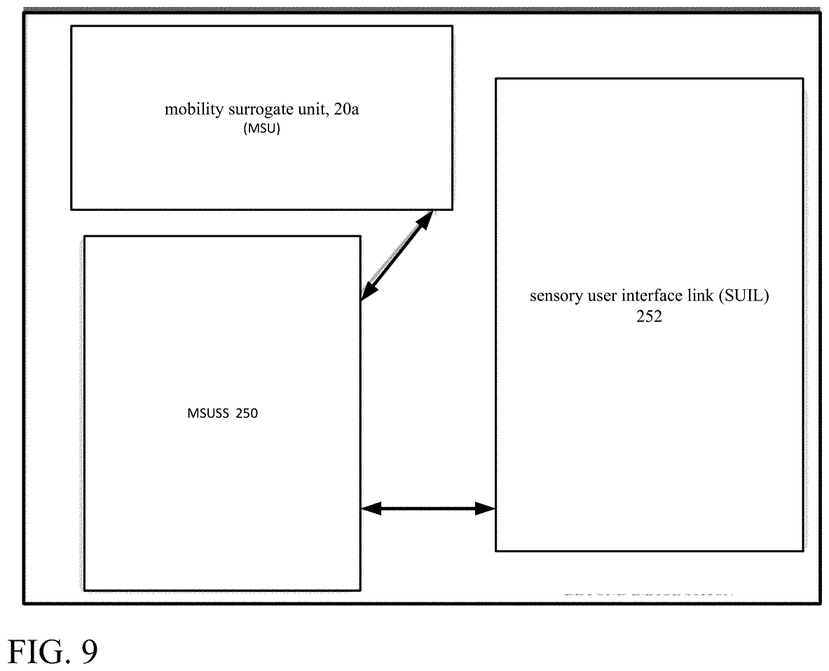

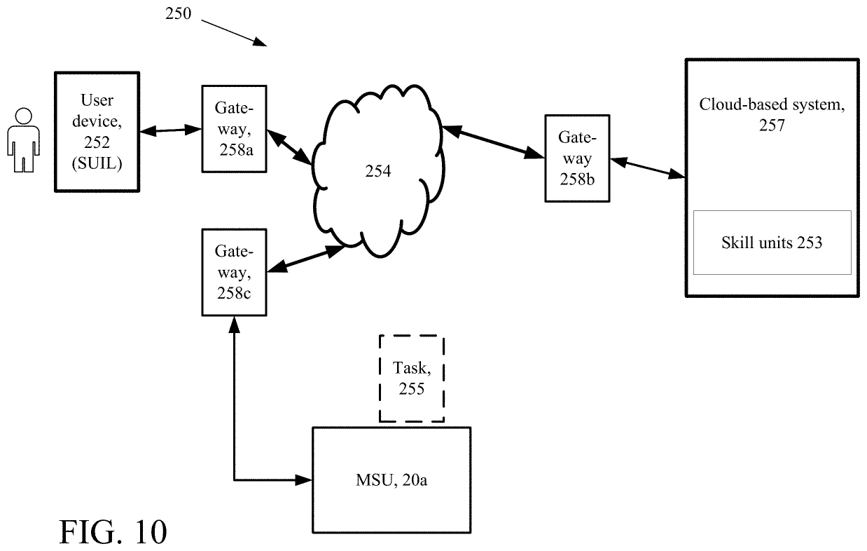

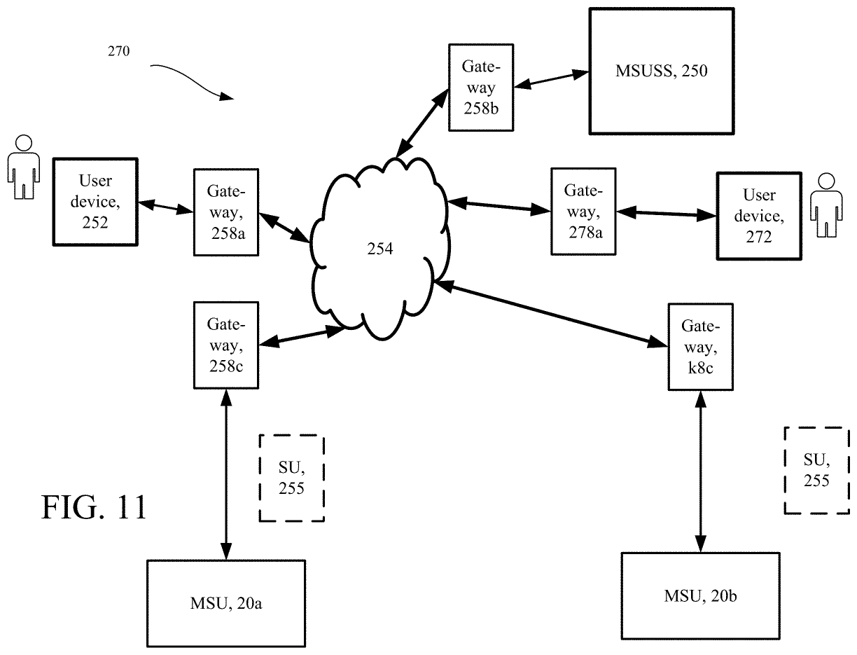

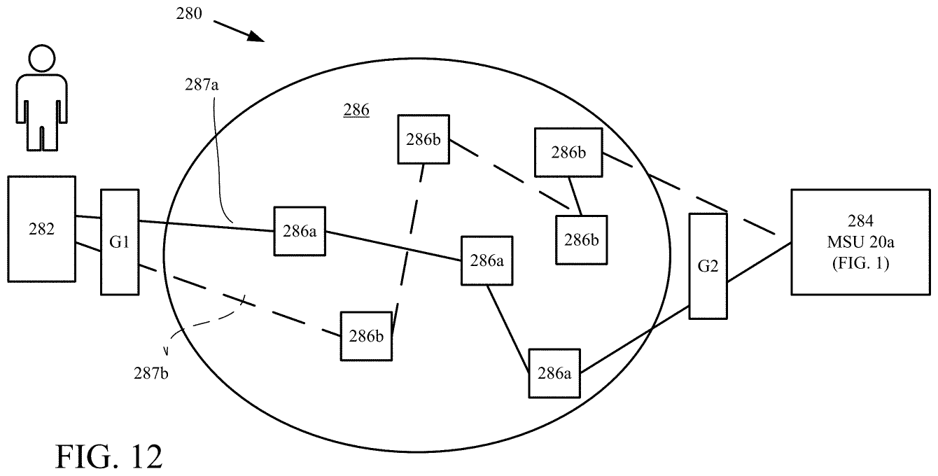

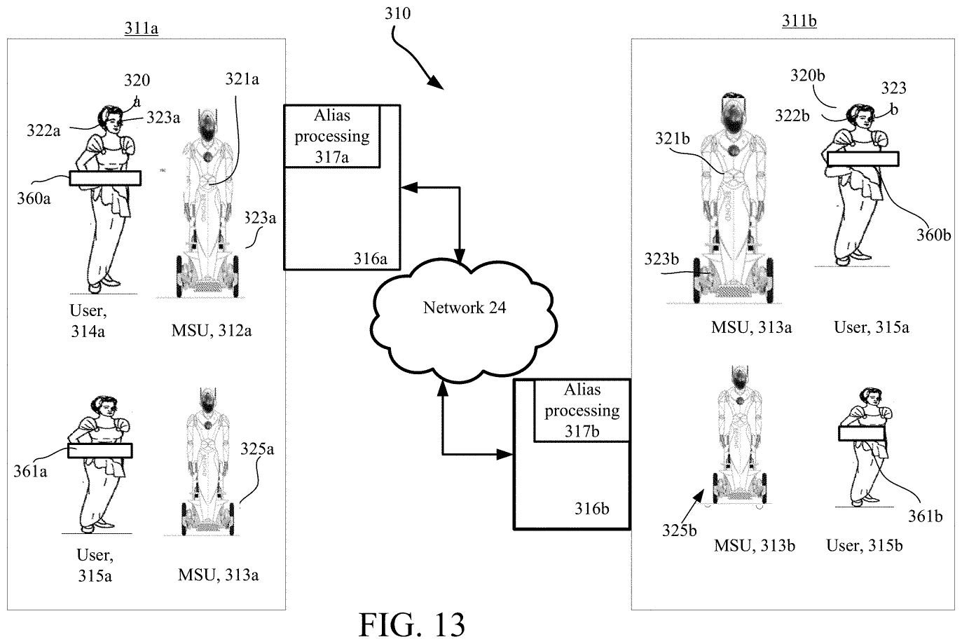

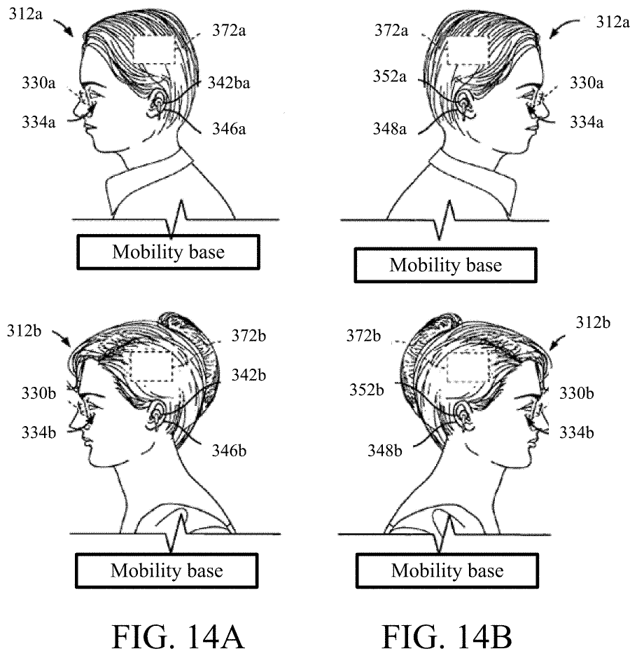

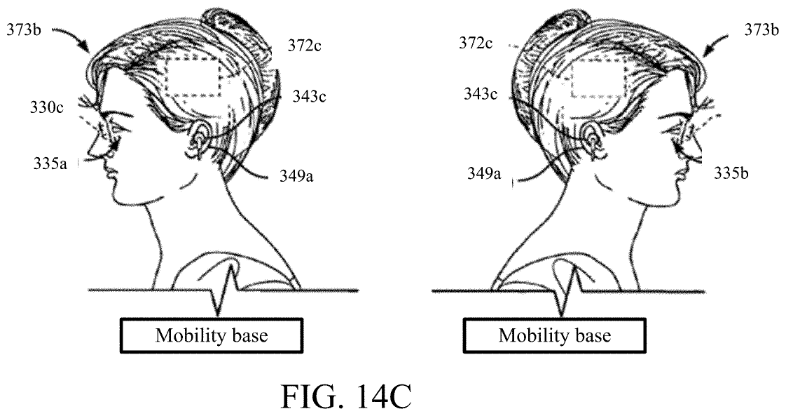

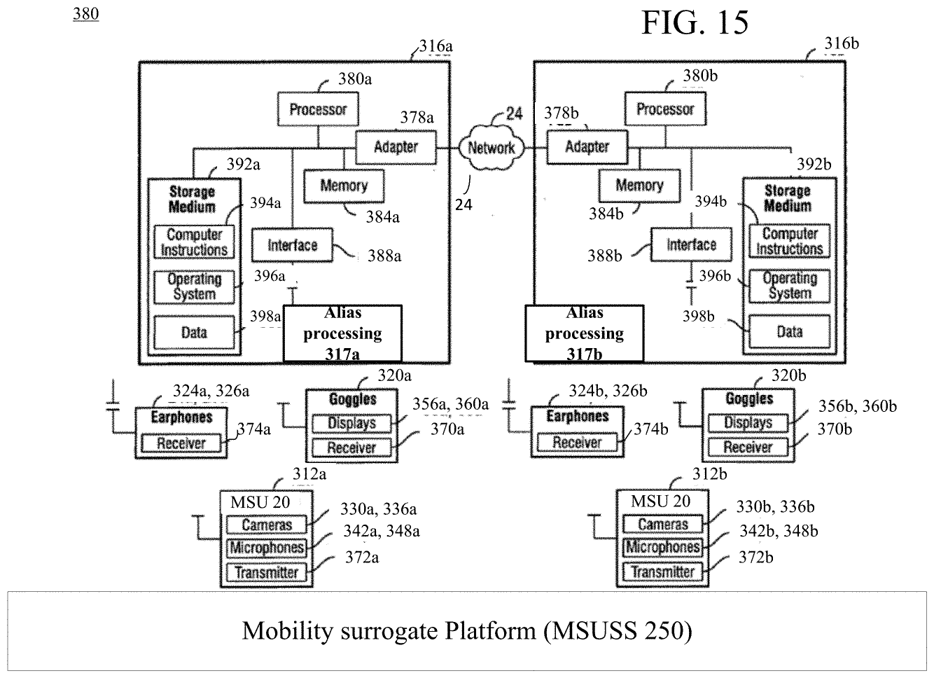

FIG. 8 shows a comparison of the PU foam with the control and two levels of paraffin wax. This figure shows that these foams are in the range for PU cushioning foam.

This Example shows that the fiber foam samples made using the blender technique are most comparable to PU cushioning foam. The density is roughly twice that of PU foam but the mechanical strength for samples containing medium amounts of binder is similar. The paraffin and carnauba waxes are effective in providing moisture resistance without suppressing the foaming ability of the mixture. Beeswax suppresses foaming and creates a denser foam that also has higher strength.

### Example 2

Preparation of High Moisture Foams

This Example describes a method of making foam composition using a blender, as in Example 1. In this Example, foams were prepared with paraffin wax and carnauba wax following the methods taught in Example 1. The foams produced can have very low density and have very good thermal insulative properties

The origin of the materials used are listed in Example 1 above. The materials and amounts used to prepare high moisture foams are listed in Table 1, below. In brief, 25 g fiber was shredded and added to a blender (BLENDTEC, 75 oz square jar) with warm (60° C.) tap water (approximately 1:70, fiber:water, or 1.5% fiber). The mixture was blended for approximately 30 seconds to disperse the fiber in water. The mixture was allowed to stand for approximately 10 to 15 minutes for the fiber to hydrate. The fiber mixture was blended again for 60 seconds, and then poured through a 50 mesh (about 88.5 mm) screen on which the fiber was deposited. The fiber was rinsed with cool tap water, then gathered into a ball and gently squeezed until the weight of the fiber:water reached 200 g total (25 g fiber+175 g water), from hereon called “moistened fiber”.

The moistened fiber was set aside while two hundred grams of cold tap water were added to the blender along with the amount of wax shown in Table 12, below. The wax was weighed and added to 200 g water. The water/wax mixture was blended on high for 2 minutes to adequately pulverize the wax into a fine powder. The moistened fiber that was set aside earlier was then added to the blender contents. The contents were then blended for 15 seconds. The 2 g of SDS was then added to the blender, and the contents were blended for one (1) minute. The mixture formed a wet foam in which the fiber and wax components were thoroughly dispersed.

TABLE 12
FORMULATION AND PROPERTIES OF HIGH MOISTURE FOAMS

| | | Paraffin | | | Carnauba | | |
|---|---|---|---|---|---|---|---|
| Sample | Control | 1 | 2 | 3 | 1 | 2 | 3 |
| Fiber (g) | 25 | 25 | 25 | 25 | 25 | 25 | 25 |
| Water (g) | 375 | 375 | 375 | 375 | 375 | 375 | 375 |
| 5% PVOH (g) | 0 | 0 | 0 | 0 | 0 | 0 | 0 |
| SDS (g) | 2 | 2 | 2 | 2 | 2 | 2 | 2 |
| Wax (g) | 0 | 3.5 | 7.0 | 14 | 3.5 | 7.0 | 14 |
| Density (g/cm³) | 0.026 | 0.032 | 0.051 | 0.067 | 0.026 | 0.047 | 0.051 |
| Shrinkage (%) | 24 | 26 | 35 | 40 | 15 | 25 | 15 |
| Water Test | Sink/dissolve | Float | Float | Float | Float | Float | Float |
| Water | 1,595 | 574 | 252 | 124 | 361 | 329 | 348 |
| Absorption | | | | | | | |
| (wt %) | | | | | | | |

The results showed that addition of wax during foam preparation, even at the lowest levels, markedly decreased water absorption compared to the control containing no wax. There was no incremental benefit from adding increasing amounts of carnauba wax. However, incremental increases in the amount of paraffin reduced water absorption during the water absorption test. Foam samples containing paraffin were denser that samples containing carnauba wax. All of the samples containing wax floated in water, whereas the control foams quickly absorbed water and disintegrated.

The information given in this example shows that even small amounts of wax added during foam preparation are enough to provide a significant benefit in moisture resistance.

### Example 3

Preparation of Low Moisture Foam Formulations

This procedure describes a method of making foam composition using a paddle mixer such as a HOBART or KITCHEN-AID mixer.

The materials and amounts used to prepare low-moisture foams are listed in Table 2, below. In brief, 25 g fiber was shredded and added to a blender (BLENDTEC, 75 oz square jar) with warm (60° C.) tap water (approximately 1:70, fiber:water or 1.5% fiber). The mixture was blended for approximately 30 seconds to disperse the fiber in water. The mixture was allowed to rest for about 10 to 15 minutes to hydrate the fiber. The hydrated fiber mixture was blended again for 60 seconds, and then poured through a 50 mesh screen on which the fiber was deposited. The fiber was rinsed with cool tap water, then gathered into a ball and rigorously squeezed until the total weight was reduced to 75 g total (25 g fiber+50 g water). The fiber ball was placed into a mixing bowl.

Two hundred grams of cold tap water were added to a blender along with the amount of wax shown in Table 2. The wax was weighed and added to 200 g water. The water/wax mixture was blended on high for 2 minutes to pulverize the wax into a fine powder that floated on the water. The pulverized wax was collected on a 50-mesh screen.

The fiber ball was placed in a KITCHEN AID mixing bowl, 50 g of a 5% solution of polyvinyl alcohol (PVOH) was added to the mixing bowl along with 2 g of the SDS solution, and pulverized wax in the amounts shown in Table 2. The contents were mixed with a paddle attachment starting at speed 3 and increased gradually to speed 10. Although the moisture content was low, the mixture slowly began to produce a foam. The mixture was stirred for approximately 10 minutes creating a foam that was approximately five times the original volume. Following the procedure of Example 1, the foam was formed into a sheet approximately 2.54 cm in thickness, and dried in an oven at 105° C. until there was no further weight loss.

TABLE 13
FORMULATION AND PROPERTIES OF LOW MOISTURE FOAMS

| | | | Carnauba | | |
|---|---|---|---|---|---|
| Sample | Control | Paraffin | 1 | 2 | 3 |
| Fiber (g) | 25 | 25 | 25 | 25 | 25 |
| Water (g) | 50 | 50 | 50 | 50 | 50 |
| 5% PVOH (g) | 50 | 50 | 50 | 50 | 50 |
| SDS (g) | 2 | 2 | 2 | 2 | 2 |
| Paraffin Wax (g) | 0 | 3.5 | 0 | 0 | 0 |
| Carnauba Wax (g) | 0 | 0 | 3.5 | 7.0 | 14 |
| Density (g/cm³) | 0.042 (0.0053) | 0.048 (0.0036) | 0.041 (0.0020) | 0.040 (0.0017) | 0.044 (0.0012) |
| Mean (Std) | | | | | |
| Shrinkage (%) | 0.4 (2.3) | 2.1 (3.5) | 0.5 (4.2) | 1.3 (3.3) | 0.8 (2.8) |
| (Stdev) | | | | | |
| Water Test | Sink/dissolve | Float | Float | Float | Float |
| Water Absorption | 1,750 (0.36) | 165 (40) | 1,317 (17) | 1,296 (54) | 1,238 (60) |
| (wt %), (Stdev) | | | | | |
| Compressive | 2.02 (0.643) | 3.11 (0.990) | 1.86 (0.544) | 2.87 (0.622) | 3.44 (0.0495) |
| Strength 10% | | | | | |
| (kPa) | | | | | |
| Modulus | 5.025 (2.04) | 3.335 (1.10) | 5.64 (1.80) | 3.695 (0.530) | 3.01 (0.283) |
| (kPa) | | | | | |

The results of this Example show that the low moisture formulations have no significant shrinkage compared to the high moisture formulations of Examples 1 and 2. All of the wax-containing samples floated in water during the immersion test, whereas the control quickly absorbed water and disintegrated. Even though the wax-containing samples absorbed water, they did not quickly disintegrate in water. Only the paraffin wax sample resisted moisture absorption. The carnauba wax samples floated on water but absorbed many times their weight in water during the 30 second immersion test. In contrast, carnauba wax samples in Example 1 had a markedly reduced amount of water absorption. The difference in absorption properties may stem from the use of PVOH in this example.

The results of this Example demonstrate that even small amounts of wax can confer moisture resistance and allow the foam to float on water. When the samples are forced under water during the immersion test, the samples absorb water, but they don't disintegrate as does the control sample. The low moisture foam samples containing waxes had similar density, compressive strength, and modulus to that of the control foams.

We claim:

1. A foam composition comprising at least one fiber component, at least one wax binder, at least one foaming agent; and optionally at least one dispersant;
wherein the at least one fiber component, the at least one foaming agent, the at least one wax binder, and when present the at least one dispersant are uniformly dispersed throughout a matrix, wherein the matrix is a foam.

2. The foam composition of claim 1, wherein the fiber component is a plant-derived complex carbohydrate, a crop waste fiber, a wood, a lignocellulosic fibrous material, a fiber crop, or a combination thereof.

3. The foam composition of claim 1, wherein the at least one wax binder is a natural waxy substance, a synthetic waxy substance, or a mixture thereof.

4. The foam composition of claim 3, wherein the at least one wax binder is a paraffin wax, a carnauba wax, a candelilla wax, a beeswax, tallow, a jojoba wax, lanolin, ambergris, a soy wax, a rice bran wax, a laurel wax, stearic acid, palmitic acid, a polycarpolactone, a polylactic acid, a polyhydrobutyrate, a polybutylene succinate, or a mixture thereof.

5. The foam composition of claim 1, wherein the at least one foaming agent is an anionic surfactant, a cationic surfactant, or a non-ionic surfactant.

6. The foam composition of claim 1, wherein the at least one foaming agent is a hydrolyzed protein formulation, a proprietary synthetic formulation used in the concrete industry, sodium dodecyl sulfate (SDS), sodium lauryl ether sulfate (SLES), a polysorbate, a monoglyceride, a sorbitan fatty ester, or a mixture thereof.

7. The foam composition of claim 1 comprising at least one dispersant, wherein the at least one dispersant is polyvinyl alcohol; a pregelatinized starch; a carboxymethyl cellulose; a carboxymethyl cellulose derivative; a hydroxymethyl cellulose; a hydroxymethyl cellulose derivative; a water-soluble viscosity modifier; a plant gum; or a combination thereof.

8. The foam composition of claim 1, wherein the foam composition comprises increased insulative thermal properties when compared to a foam composition not comprising at least one wax binder.

9. The foam composition of claim 1, wherein the foam composition comprises increased acoustic insulative properties when compared to a foam composition not comprising at least one wax binder.

10. A moisture resistant, dense, and stable foam product prepared with the foam composition of claim 1.

11. A moisture resistant, dense, and stable foam product prepared with the foam composition of claim 7, wherein the foam has higher rigidity than a foam product not comprising a dispersing agent.

12. A moisture resistant article of manufacture prepared with the foam composition of claim 1.

13. The article of manufacture of claim 12, wherein the article is compression molded.

14. The article of manufacture of claim 12, wherein the article of manufacture is a take-out container, a shipping container cushioning material, or a shipping container packaging material.

15. A process for a making a foam composition, the process comprising:
a) mixing a fiber component with water to create a hydrated fiber;
b) removing excess water from the hydrated fiber to create:
i) a high moisture fiber with at least about 5 parts water per every part fiber; or
ii) a low moisture fiber with at least about 1 part water per every part fiber to at least about 4.5 parts water per every part fiber; and
c) blending with the moistened fiber of i) or the low moisture fiber of ii) at least one wax binder.

16. The process of claim 15, further comprising mixing a foaming agent into the high moisture fiber of i) blended with the at least one wax binder; and
molding the foam.

17. The process of claim 15, further comprising mixing a dispersant and a foaming agent when blending in the at least one wax binder with the low moisture fiber of ii); and
molding the foam.

18. The process of claim 15, wherein the high moisture fiber of i) has about 7 parts water per part fiber.

19. The process of claim 15, wherein the low moisture fiber of ii) has about 2 parts water per part fiber.

20. The process of claim 15, wherein the fiber component is at least one of a plant-derived complex carbohydrate, a crop waste fiber, a wood, a lignocellulosic fibrous material, a fiber crop, or a combination thereof.

21. The process of claim 15, wherein the at least one wax binder is a natural waxy substance, a synthetic waxy substance, or a mixture thereof.

22. The process of claim 21, wherein the at least one wax binder is paraffin wax, carnauba wax, candelilla wax, beeswax, tallow, jojoba wax, lanolin, ambergris, soy wax, rice bran wax, laurel wax, a polycarpolactone, a polylactic acid, a polyhydrobutyrate, a polybutylene succinate, or a mixture thereof.
